(19) United States
(12) Patent Application Publication
(10) Pub. No.: US 2021/0227341 A1
(43) Pub. Date: Jul. 22, 2021

(54) Earphone with Volume Monitoring

(71) Applicant: Innovation Sound Technology Co., Ltd., Shenzhen (CN)

(72) Inventors: Shun Ming Yuen, Shenzhen (CN); Wai Yin Mung, Shenzhen (CN); Ka Ming Wu, Shenzhen (CN)

(21) Appl. No.: 17/224,080

(22) Filed: Apr. 6, 2021

Related U.S. Application Data
(63) Continuation of application No. PCT/CN2019/084043, filed on Apr. 24, 2019.

(30) Foreign Application Priority Data
Mar. 4, 2019 (CN) 201920265937.X

(51) Int. Cl. H04R 29/00; H04R 1/10; H04R 5/033; H04R 5/04; H04R 1/08; G10L 25/51; H04S 1/00; H01Q 1/27

(52) U.S. Cl. CPC H04R 29/001; H04R 1/105; H04R 1/1008; H04R 1/1041; H04R 1/1075; H04S 2400/13; H04R 5/04; H04R 1/08; G10L 25/51; H04S 1/007; H01Q 1/273; H04R 5/0335

(57) ABSTRACT

The application belongs to the field of earphone technology, and discloses an earphone with volume monitoring. If it is found that the external noise is louder than the noise detected by the right-channel microphone 1 and the left-channel microphone 1, the volume will be increased. The left-channel microphone 2 and the right-channel microphone 2 are used to monitor the volume increased by the user. If it exceeds the standard, the earphone will give a prompt. If the volume exceeds the standard, the micro-control unit will prompt the speaker, or immediately stop the volume or restore the volume to an appropriate level.

### CROSS REFERENCE TO RELATED APPLICATIONS

The present application is a Continuation Application of PCT Application No. PCT/CN2019/084043 filed on Apr. 24, 2019, which claims the benefit of Chinese Patent Application No. 201920265937.X filed on Mar. 4, 2019. All the above are hereby incorporated by reference.

### FIELD OF THE INVENTION

The application specifically relates to a type of earphones with volume monitoring, which belongs to the field of earphone technology.

### BACKGROUND OF THE INVENTION

The WHO and ITU recently announced non-binding recommendations, calling for mobile phones and portable music players to include protective measures to prevent users from permanent hearing damage to their ears as a result of listening to loud music, watching movies, playing video games, etc. in a long-term use of headphones.

In a quiet indoor environment, the background noise shall be only about 40 dBA; in a general bus, the highest noise is about 90 dBA; in a noise concert environment, the highest noise is about 110 dBA; for the hand-held ground drilling tool used to cut pavements, the highest noise is about 120 dBA; for a civil aircraft landing or taking off, the highest noise is about 130 dBA when passing by at a very low altitude. The worst case is 140 dBA or above, which may make the ear permanently deaf.

As mobile phones and earphones have become popular, especially students or teenagers, who like to use mobile phones for a long time, unconsciously grow up with time and age without realizing that their hearing is beginning to suffer.

### CONTENT OF THE APPLICATION

The technical problem to be solved by the application is to overcome the existing defects and to provide an earphone with volume monitoring. A right-channel microphone 1 and a left-channel microphone 1 are used to collect external noise, and the output ends of the right-channel microphone 1 and the left-channel microphone 1 are connected with the input end of the micro-control unit for inputting the collected information to the micro-control unit. A left-channel microphone 2 and a right-channel microphone 2 are used to collect the sound output from a left-channel speaker and a right channel speaker respectively. Moreover, the output ends of the left-channel microphone 2 and the right-channel microphone 2 are connected to the input end of the micro-control unit, and the collected sound is input to the micro-control unit. If it is found that the external noise is louder than the noise detected by the right-channel microphone 1 and the left-channel microphone 1, and the user increases the volume due to the large external noise, the right-channel speaker and the left-channel speaker will emit sound in an increased volume. The left-channel microphone 2 and the right-channel microphone 2 are used to monitor the volume increased by the user. If it exceeds the standard, the earphone will give a prompt. When the signals detected by the left-channel microphone 2 and the right-channel microphone 2 enter the micro-control unit where the volume level is detected, if the volume exceeds the standard, the micro-control unit will prompt the speaker, or immediately stop the volume or restore the volume to an appropriate level. The application can effectively solve the problems in the background of the invention.

In order to solve the above technical problems, the present application provides the following technical solutions:

This application provides an earphone with volume monitoring, comprising a headband, the two ends of which are respectively fixed to a shell, one side of which is fixed to speaker cotton. A sub-board is fixed inside the shell at one end of the headband, and is connected to a main board through the headband. A right-channel microphone 1 and a right-channel microphone 2 are respectively attached on both sides of the sub-board. A right-channel speaker is arranged on the upper part of the right-channel microphone 2. A main board is also fixed inside the shell at the other end of the headband, and a left-channel microphone 2 and a left-channel microphone 1 are attached on the both sides of the main board respectively. The upper part of the left-channel microphone 2 is provided with a left-channel speaker.

As a preferred technical solution of the application, the upper part of the main board is also fixed with a micro-control unit. A right-channel microphone 1 and a left-channel microphone 1 are used to collect external noise, and the output ends of the right-channel microphone 1 and the left-channel microphone 1 are connected with the input end of the micro-control unit for inputting the collected information to the micro-control unit.

As a preferred technical solution of the application, a left-channel microphone 2 and a right-channel microphone 2 are used to collect the sound output from a left-channel speaker and a right channel speaker respectively. Moreover, the output ends of the left-channel microphone 2 and the right-channel microphone 2 are connected to the input end of the micro-control unit, and the collected sound is input to the micro-control unit.

As a preferred technical solution of the application, an antenna is also fixed on the upper part of the main board, and the input end of the micro-control unit is connected to the output end of the antenna.

As a preferred technical solution of the application, the upper part of the main board is also attached with a D/A converter and an amplifier. The digital signals at the output end of the micro-control unit are converted into analog signals by the D/A converter, and the input signals are amplified in voltage or power by the amplifier before being transmitted to the right-channel speaker and the left channel-speaker.

Beneficial effects achieved by the application: A right-channel microphone 1 and a left-channel microphone 1 are used to collect external noise, and the output ends of the right-channel microphone 1 and the left-channel microphone 1 are connected with the input end of the micro-control unit for inputting the collected information to the micro-control unit. A left-channel microphone 2 and a right-channel microphone 2 are used to collect the sound output from a left-channel speaker and a right channel speaker respectively. Moreover, the output ends of the left-channel microphone 2 and the right-channel microphone 2 are connected to the input end of the micro-control unit, and the collected sound is input to the micro-control unit. If it is found that the external noise is louder than the noise detected by the right-channel microphone 1 and the left-channel microphone 1, and the user increases the volume due to the large external noise, the right-channel speaker and the left-channel speaker will emit sound in an increased volume. The left-channel microphone 2 and the right-channel microphone 2 are used to monitor the volume increased by the user. If it exceeds the standard, the earphone will give a prompt. When the signals detected by the left-channel microphone 2 and the right-channel microphone 2 enter the micro-control unit where the volume level is detected, if the volume exceeds the standard, the micro-control unit will prompt the speaker, or it can immediately stop the volume or restore the volume to an appropriate level.

### BRIEF INTRODUCTION OF THE DRAWINGS

The accompanying drawings are used to provide a further understanding of the application and constitute a part of the Specification. Together with the embodiments of the application, they are intended to interpret the application but do not constitute a limitation to the application.

In the accompanying drawings:

FIG. 1 is a schematic diagram for the overall structure of an earphone with volume monitoring according to embodiments of the application;

FIG. 2 is a circuit diagram of an earphone with volume monitoring according to embodiments of the application;

Numbers in the drawings: 1. Headband; 2. Shell; 3. Right-channel microphone 1; 4. Right-channel speaker; 5. Speaker cotton; 6. Right-channel microphone 2; 7. Left-channel microphone 2; 8. Left-channel speaker; 9. Main board; 10. Left-channel microphone 1; 11. Micro-control unit; 12. D/A converter; 13. Antenna; 14. Amplifier; 15. Sub-board.

### DETAILED DESCRIPTION OF THE PREFERRED EMBODIMENTS

The preferred embodiments of the application are described below in conjunction with the drawings. It shall be understood that the preferred embodiments described herein are only used to illustrate and interpret the present application, rather than to limit the present application.

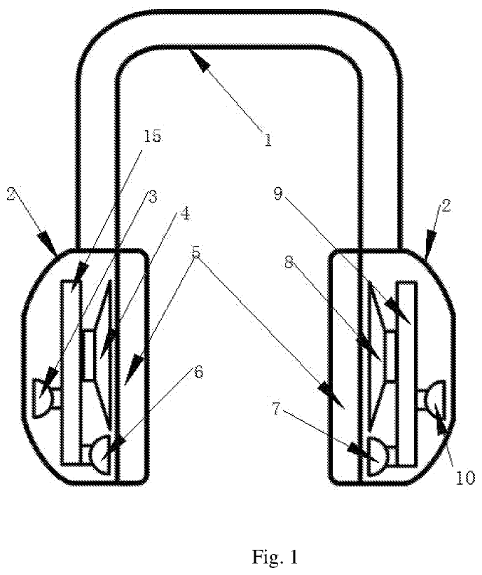

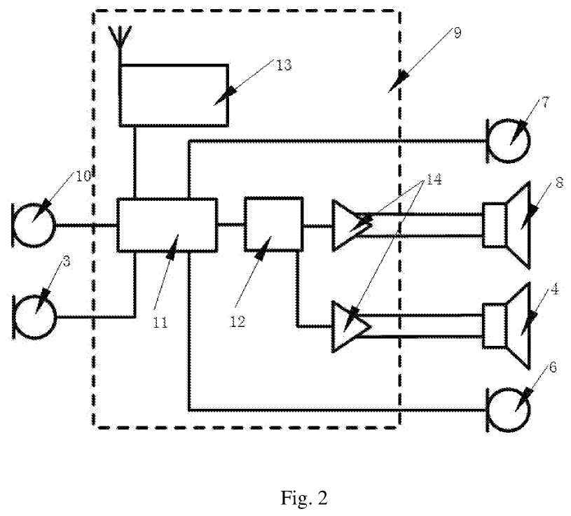

Embodiments: Please refer to FIG. 1-2. This application provides an earphone with volume monitoring, comprising a headband 1, the two ends of which are respectively fixed to a shell 2, one side of which is fixed to speaker cotton. A sub-board 15 is fixed inside the shell 2 at one end of the headband 1, and is connected to a main board 9 through the headband 1. A right-channel microphone 1 (3) and a right-channel microphone 2 (6) are respectively attached on both sides of the sub-board 15. A right-channel speaker 4 is arranged on the upper part of the right-channel microphone 2 (6). A main board 9 is also fixed inside the shell 2 at the other end of the headband 1, and a left-channel microphone 2 (7) and a left-channel microphone 1 (10) are attached on the both sides of the main board 9 respectively. The upper part of the left-channel microphone 2 (7) is provided with a left-channel speaker 8.

Further, the upper part of the main board is fixed with the micro-control unit 11. A right-channel microphone 1 (3) and a left-channel microphone 1 (10) are used to collect external noise, and the output ends of the right-channel microphone 1 (3) and the left-channel microphone 1 (10) are connected with the input end of the micro-control unit 11 for inputting the collected information to the micro-control unit 11.

Further, the left-channel microphone 2 (7) and the right-channel microphone 2 (6) are used to collect the sound output from a left-channel speaker 8 and a right channel speaker 4 respectively. Moreover, the output ends of the left-channel microphone 2 (7) and the right-channel microphone 2 (6) are connected to the input end of the micro-control unit, and the collected sound is input to the micro-control unit 11.

Further, an antenna 13 is also fixed on the upper part of the main board 9, and the input end of the micro-control unit is connected to the output end of the antenna 13.

Further, the upper part of the main board 9 is also attached with a D/A converter 12 and an amplifier 14. The digital signals at the output end of the micro-control unit 11 are converted into analog signals by the D/A converter 12, and the input signals are amplified in voltage or power by the amplifier 14 before being transmitted to the right-channel speaker 4 and the left channel-speaker 8.

Working principle: A right-channel microphone 1 and a left-channel microphone 1 are used to collect external noise, and the output ends of the right-channel microphone 1 and the left-channel microphone 1 are connected with the input end of the micro-control unit for inputting the collected information to the micro-control unit. A left-channel microphone 2 and a right-channel microphone 2 are used to collect the sound output from a left-channel speaker and a right channel speaker respectively. Moreover, the output ends of the left-channel microphone 2 and the right-channel microphone 2 are connected to the input end of the micro-control unit, and the collected sound is input to the micro-control unit. If it is found that the external noise is louder than the noise detected by the right-channel microphone 1 and the left-channel microphone 1, and the user increases the volume due to the large external noise, the right-channel speaker and the left-channel speaker will emit sound in an increased volume. The left-channel microphone 2 and the right-channel microphone 2 are used to monitor the volume increased by the user. If it exceeds the standard, the earphone will give a prompt. When the signals detected by the left-channel microphone 2 and the right-channel microphone 2 enter the micro-control unit where the volume level is detected, if the volume exceeds the standard, the micro-control unit will prompt the speaker, or it can immediately stop the volume or restore the volume to an appropriate level.

Last thing to note: The above descriptions are only preferred embodiments of the present invention, and are not used to limit the application. Although the application has been described in detail with reference to the foregoing embodiments, those skilled in the art may still modify the technical solutions described in the foregoing embodiments, or equivalently replace some of the technical features. Any modification, equivalent replacement, improvement, etc. made within the spirit and principle of the application shall be included in the protection scope of the application.

What is claimed is:

1. An earphone with volume monitoring, comprising a headband (1), wherein the two ends of the headband (1) are respectively fixed to a shell (2), and one side of which is attached to speaker cotton (5); a sub-board (15) is fixed inside the shell (2) at one end of the headband (1), and is connected to a main board (9) through the headband (1); a right-channel microphone 1 (3) and a right-channel microphone 2 (6) are respectively attached on both sides of the sub-board (15); a right-channel speaker (4) is arranged on the upper part of the right-channel microphone 2 (6); a main board (9) is also fixed inside the shell (2) at the other end of the headband (1), and a left-channel microphone 2 (7) and a left-channel microphone 1 (10) are attached on the both sides of the main board (9) respectively; the upper part of the left-channel microphone 2 (7) is provided with a left-channel speaker (8).

2. An earphone with volume monitoring according to claim 1, wherein the upper part of the main board (9) is also fixed with a micro-control unit (11); a right-channel microphone 1 (3) and a left-channel microphone 1 (10) are used to collect external noise, and the output ends of the right-channel microphone 1 (3) and the left-channel microphone 1 (10) are connected with the input end of the micro-control unit (11) for inputting the collected information to the micro-control unit (11).

3. An earphone with volume monitoring according to claim 2, wherein a left-channel microphone 2 (7) and a right-channel microphone 2 (6) are used to collect the sound output from a left-channel speaker (8) and a right channel speaker (4) respectively; the output ends of the left-channel microphone 2 (7) and the right-channel microphone 2 (6) are connected with the input end of the micro-control unit (11) such that the collected sound is input to the micro-control unit (11).

4. An earphone with volume monitoring according to claim 2, wherein an antenna (13) is also fixed on the upper part of the main board (9), and the input end of the micro-control unit (11) is connected to the output end of the antenna (13).

5. An earphone with volume monitoring according to claim 2, wherein the upper part of the main board (9) is also attached with a D/A converter (12) and an amplifier (14); the digital signals at the output end of the micro-control unit (11) are converted into analog signals by the D/A converter (12), and the input signals are amplified in voltage or power by the amplifier (14) before being transmitted to the right-channel speaker (4) and the left channel-speaker (8).
